(19) United States
(12) Patent Application Publication
(10) Pub. No.: US 2007/0118757 A1
(43) Pub. Date: May 24, 2007

(54) Method, apparatus, and system for securing data on a removable memory device

(76) Inventors: David N. Skinner, Redwood Shores, CA (US); Yancy Chen, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/268,155

(22) Filed: Nov. 7, 2005

(51) Int. Cl. H04K 1/00

(52) U.S. Cl. 713/186

(57) ABSTRACT

A method, apparatus, and system for securing data on a removable memory device, which is removably coupled to and accessible by a computing apparatus, are disclosed. Upon an attempt by a user to access the removable memory device, a biometric key is recovered by a biometric key interface device. This biometric key is used to authenticate an identity of the user. Upon the authentication, where the user identity corresponds to authorized access to the memory device, the access is enabled. Upon the authentication where the user identity does not correspond to authorized access to the memory device, the access is prohibited.

### TECHNICAL FIELD

An embodiment of the present invention relates to the field of data protection for computer memory systems. More specifically, embodiments of the present invention relate to securing access to removable memory devices and controlling access to removable memory devices on the basis of an identity authenticated by a biometric parameter.

### BACKGROUND

Removable memory devices are found in a wide variety of data-processing systems. Not only traditional data-processing devices such as laptop computers, but other digital equipment such as hand-held computing devices, cameras, personal digital assistants, video gaming consoles, digital video recorders, digital entertainment equipment, and calculators may include hardware, software, and operating system support for removable memory devices.

In the past, removable memory devices were limited to relatively small capacity, low performance solid-state devices, such as flash memory cards. But with improvements in rotating magnetic storage technology, practical and affordable removable disk drive designs have become common. These removable memory devices offer substantial improvements in capacity, performance, and practicality. In addition, advances in digital technology have increased the storage capacity available in a practical removable solid state memory device. Finally, emerging technologies promise grater capacities with better performance and lower costs aimed at the portable and removable storage markets.

As capacity, performance, and usefulness of removable memory devices continue to improve, many data processing systems have begun to rely on removable memory devices for the majority of the system's non-volatile storage. Even large desktop computing systems employ removable memory devices to facilitate data portability between systems. For example, a user can carry large quantities of data from home to work, or while traveling, increasing productivity. Other uses include archiving data, and storing digital entertainment data, such as video or music, for use later.

One result of these advances in removable and portable memory devices is that users tend to store much more data on removable memory devices. As removable memory device reliability has improved, a larger quantity of mission-critical or sensitive data is being stored on removable memory devices. Furthermore, as the devices have become smaller, more desirable, and more common it is inevitable that a larger number of them are eventually possessed by persons who do not own nor have permission to access the data on the removable memory devices in their possession.

While having this data easily portable and available is advantageous to the intended users, the potentially sensitive nature, personal aspects, and financial value of the data that may be stored on a removable storage device make it essential that the data remain secure, even if the removable memory device is not in the authorized user's possession.

Traditionally, access to data has been restricted by password controls. But passwords are often inadequate; consumers regularly construct passwords based on easily guessed words or numbers, and will often neglect to change default passwords. Furthermore, the high performance data interface that makes these devices attractive to customers also enables high-speed password attacks. Therefore, what is needed is a means to provide greater security without the potential weakness of a password system nor requiring an inconvenient random password that will keep the removable memory device secure any time it is not in an authorized user's possession.

### SUMMARY

A method, apparatus, and system for securing data on a removable memory device, which is removably coupled to and accessible by a computing apparatus, are disclosed. Upon an attempt by a user to access the removable memory device, a biometric key is recovered by a biometric key interface device, authenticating an identity of the user. Upon the authentication where the user identity corresponds to authorized access to the memory device, the access is enabled. Upon the authentication where the user identity does not correspond to authorized access to the memory device, the access is prohibited.

### BRIEF DESCRIPTION OF THE DRAWINGS

The accompanying drawings, which are incorporated in and form a part of this specification, illustrate embodiments of the invention and, together with the description, serve to explain the principles of the invention. These drawings depict exemplary embodiments and are not meant to limit the present invention. For instance, FIG. 1 is not to be interpreted as limiting the invention to a personal computer data processing apparatus. The drawings are not to scale.

FIG. 1 depicts an exemplary data processing apparatus in accordance with one embodiment of the present invention.

FIG. 2 depicts an exemplary removable memory device with an apparatus for securing electronic data access based on a biometric key according to an embodiment of the present invention.

FIG. 3 depicts an exemplary removable memory device with an apparatus for securing physical access based on a biometric key according to an embodiment of the present invention.

FIG. 4 depicts an exemplary removable memory device security system according to an embodiment of the present invention.

FIG. 5 is a flowchart of an exemplary process for securing a removable memory device from access by an unauthorized user according to an embodiment of the present invention.

FIG. 6 shows an exemplary removable memory device having a security processor, an electronic access controller, a security status indicator, and a biometric key interface in accordance with an embodiment of the present invention.

FIG. 7 shows an example of a user interfacing with an exemplary removable memory device having a biometric key interface in accordance with an embodiment of the present invention.

FIG. 8 depicts aspects of an exemplary removable memory device removably coupled to a data processing apparatus having a security processor, biometric key interface, and mechanical access controller in accordance with an embodiment of the present invention.

FIG. 9 depicts an exemplary removable memory device having a security processor, mechanical access controller, electronic access controller, biometric key interface and an industry-standard removable memory device in a “secured” mode in accordance with an embodiment of the present invention.

FIG. 10 depicts an exemplary removable memory device having a security processor, mechanical access controller, electronic access controller, biometric key interface and an industry-standard removable memory device an “accessible” mode in accordance with an embodiment of the present invention.

### DETAILED DESCRIPTION

A method, apparatus, and system for securing access to a removable memory device are described herein. Reference is now made in detail to exemplary embodiments of the invention, examples of which are illustrated in the accompanying drawing figures. While the invention is described herein in conjunction with these exemplary embodiments, this description is not intended to limit the invention to these embodiments. On the contrary, the invention is intended to cover alternatives, modifications and equivalents, which may be included within the spirit and scope of the invention as defined by the appended claims.

Furthermore, in the following detailed description of exemplary embodiments of the present invention, numerous specific details are set forth in order to provide a thorough understanding of the present invention. However, one of ordinary skill in the art will realize that embodiments of the present invention may be practiced without these specific details. In other instances, well-known devices, circuits, methods, processes, procedures, systems, components, and apparatus, etc. have not been described in detail so as not to unnecessarily obscure aspects of the present invention. In particular, a “biometric key interface” may include any type of biometric-driven device that produces a signal, state, output, etc, which can be correlated to a user's identity, condition, proximity, presence, etc. Further, a “mechanical access device” may include any type of mechanical, electromechanical, hydraulic, pneumatic, etc device that can effectively latch, contain, constrain, or prohibit physical movement between at least two components.

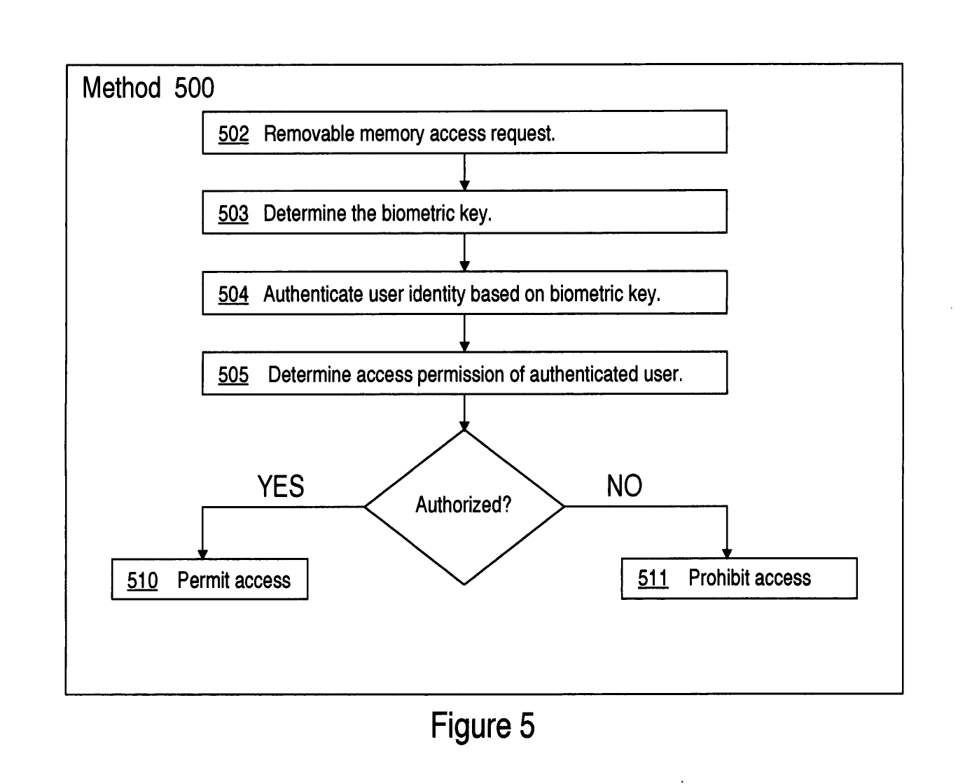

A portion of the detailed description that follows is presented and discussed in terms of a method. Although steps and sequencing thereof are disclosed in a figure herein (e.g., FIG. 5) describing the operations of this method (e.g., process 500), such steps and sequencing are exemplary. Embodiments of the present invention are well suited to performing various other steps or variations of the steps recited in the flowchart of the figure herein, and in a sequence other than that depicted and described herein.

Embodiments of the present invention provide an apparatus, system, and a method for securing access to a removable memory device. In one embodiment, security is established by a biometric key, activated with biometric information corresponding to a user provided by a user. The key is used to effectively identify the user, the user's proximity, and establish the data access permissions. In one embodiment the removable memory device is secured by controlling the electronic signals between the removable memory device and the data processing apparatus it is attached to. In one embodiment the removable memory device is secured by physically constraining the removable memory device within the data processing apparatus, effectively preventing the removal of the removable memory device. An embodiment of the present invention provides a computer implemented method for controlling access to a removable memory device.

In one embodiment, a removable memory device includes a form a user must grip in order to remove the device from a data processing apparatus. The form includes two biometric key interface devices that are engaged by the user's thumb and finger. Subsequent removal of the memory device is ultimately controlled in accordance with the methods of this invention based on user identity data provided by the biometric key interfaces.

In one embodiment, a biometric key interface comprises a fingerprint scanner. In other embodiments, another biometric scanner/reader is used. Aside from the biometric mechanism used therewith, these embodiments operate in a manner substantially analogous to the operation of the fingerprint scanner described herein and are thus exemplified therewith.

Therefore, embodiments of the present invention provide an increased level of security over present password and data encryption methods; permitting access to a removable memory device to an authorized user and preventing access to a removable memory device to a user who is not an authorized accessor. Further, embodiments of the present invention employ a biometric key interface to eliminate the use of passwords and the inherent security weaknesses therein.

Exemplary Data Processing Apparatus with Removable Memory

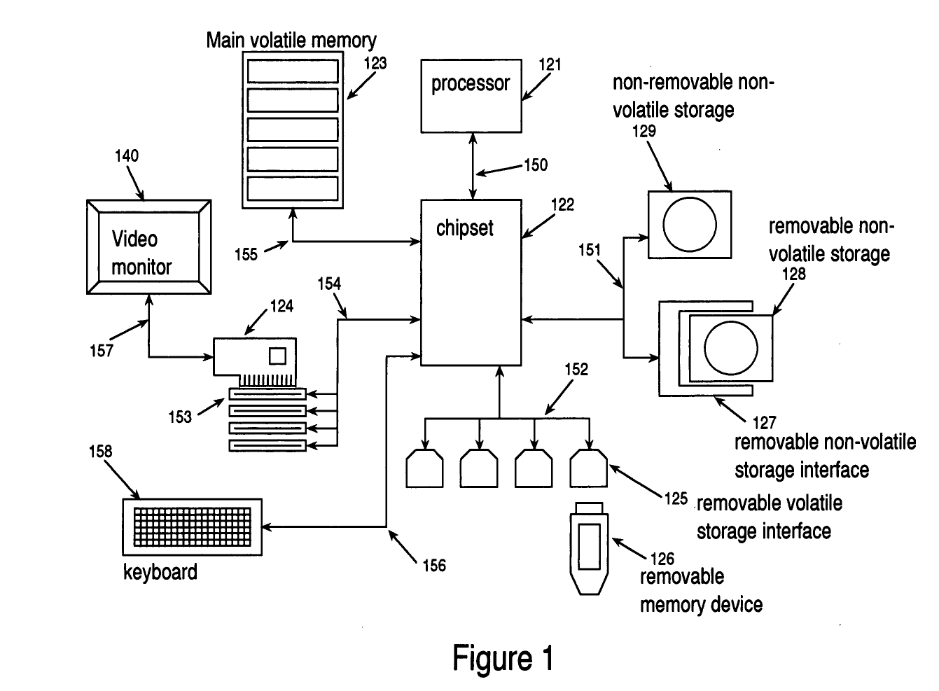

FIG. 1 depicts a functional block diagram of an exemplary data processing apparatus according to an embodiment of the present invention. Processor 121 is connected by data bus 150 to chipset 122. Chipset 122 provides data interconnection paths and access arbitration to the other peripheral components of the data processing apparatus. Main volatile memory bank 123 is connected to chipset 122 via memory bus 155. Expansion slots, one of which is denoted 153, are connected to the chipset via expansion bus 154. Video adapter board 124 is attached to expansion slot 153 and drives video monitor 140 via video cable 157 to provide user output. Keyboard 158 is connected to chipset 122 via cable 156 for user input. Interface connector 125, is connected to chipset 122 via data interconnect bus 152. Removable memory device 126 is removably coupled with interface 125. Interface 125 provides bidirectional data, device control, bus control, and power source to removable memory device 126. Chipset 122 is attached to expansion bus 151, which carries bi-directional data, device control, bus control, and power source to non-removable, non-volatile storage 129. Expansion bus 151 also carries bi-directional data, device control, bus control, and power source to interface 127. Removable memory device 128 is removably coupled with interface 127. Interface 127 provides any combination of bidirectional data, device control, bus control, and power source to removable memory device 128.

Exemplary Eletronic Removable Memory Securing Apparatus

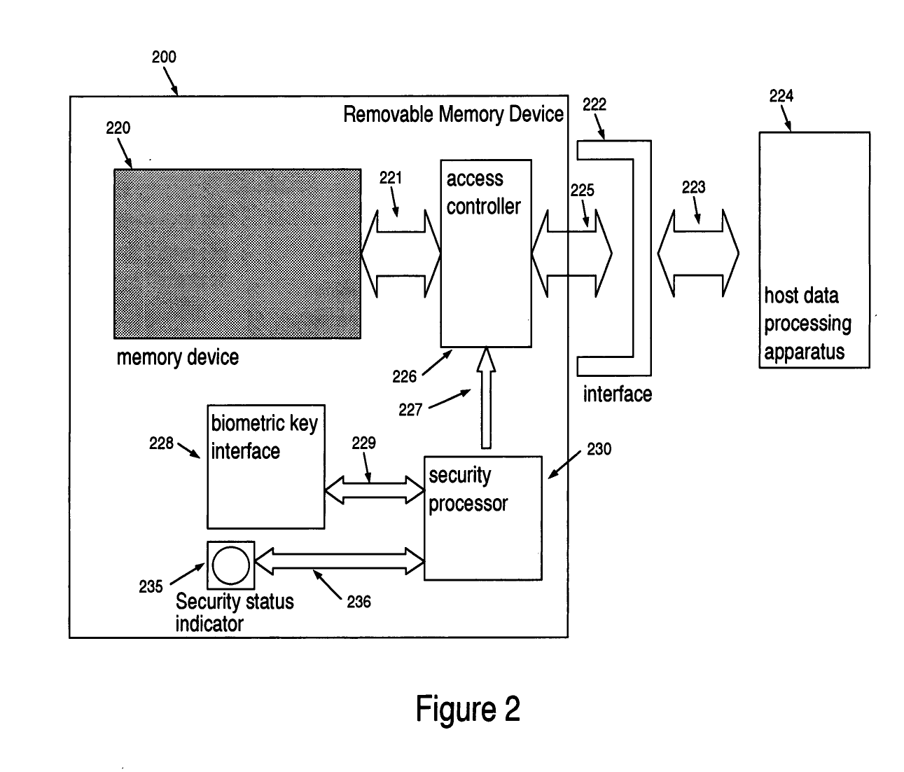

FIG. 2 depicts a functional block diagram of an exemplary data securing apparatus according to an embodiment of the present invention. In this example, removable memory device 200 is removably coupled to the host data processing apparatus 224 via interface 222 and expansion bus 223. Interface 222 may provide any combination of mechanical, electrical power, data, and device control functions to removable memory device 200.

Removable memory device 200 contains memory device 220, which stores user data. Memory device 220 is connected to electronic access controller 226 via digital bus 221. Electronic access controller 226 performs a switch function selectively permitting or prohibiting data transfer between the host data processing apparatus interface 222 and memory device 220 via removable memory device interface connector 225, subject to control signals from security processor 230 via control bus 227.

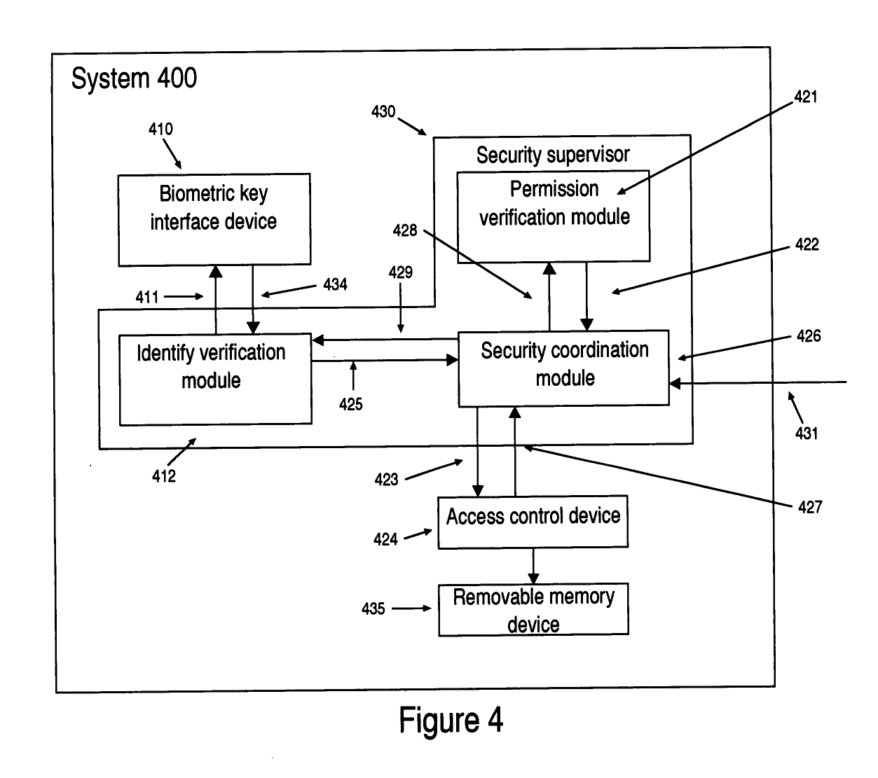

Biometric key interface 228 recovers biometric identity data from a user for use by security processor 230. Biometric key interface 228 is electrically coupled to and communicates with security processor 230 via interconnect bus 229. Security processor 230 controls electronic access controller 226 via control bus 227 to allow or deny access to memory device 220 via digital bus 221 in accordance with a suitable algorithm, e.g. the System 4 described in FIG. 4 and Method 500 in FIG. 5.

Security status indicator 235 is controlled by security processor 230 via control bus 236. Security status indicator 235 provides a visual indication of memory device 220's access permission. In this example, security status indicator 235 consists of a light emitting diode that produces a red indication to indicate access is denied to memory device 220. Security status indicator 235 also produces a green indication to inform a user that access to memory device 220 is permitted.

It is appreciated that as long as electronic access controller 226 remains in the “prohibit” function, as instructed by security processor 230, no access to memory device 220 is possible. It is also appreciated that the memory device exemplified herein with reference to memory device 220 can have any shape, size, configuration, orientation, etc., and can house any kind of memory device, disk drive, circuitry, electronic apparatus, etc.

It is further appreciated that the embodiments of the present invention may be practiced with functionality, exemplified herein with reference to security status indicator 235, in such a way that the nature of security status indicator 235 is not limited to a light emitting diode. In fact, security status indicator 235 may consist of one or more of a variety of indicators useful to the function of the removable memory device, including any or all of visual indicators, audible indicators, tactile indicators, electronic signals, etc.

Exemplary Mechanical Removable Memory Securing Apparatus

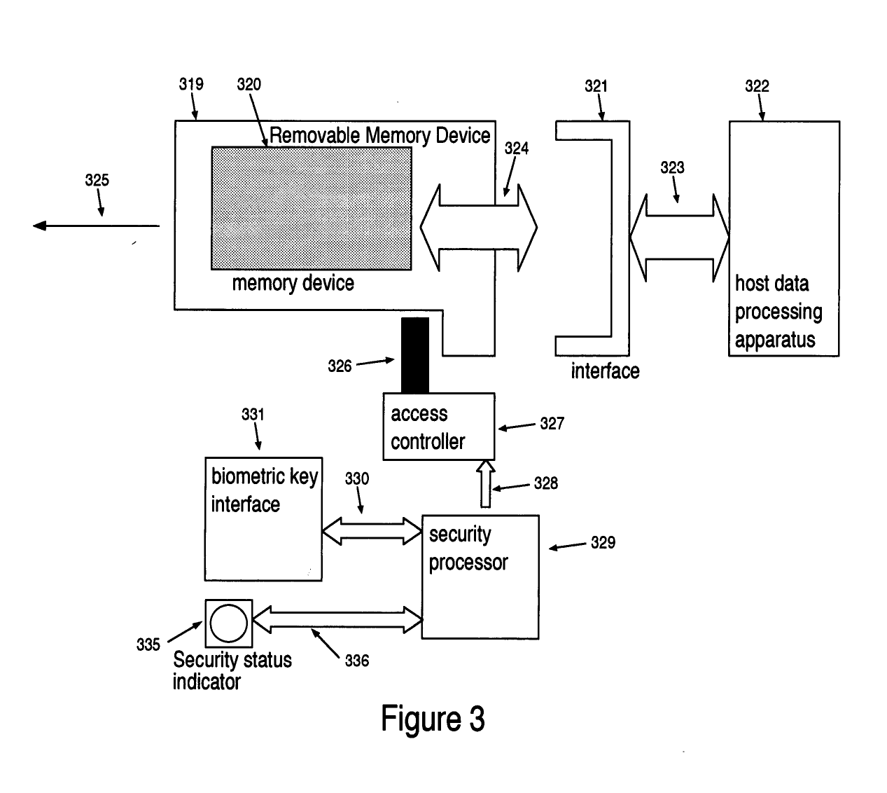

FIG. 3 depicts a functional block diagram of an exemplary removable memory device securing apparatus according to an embodiment of the present invention. In this example, interface 321 is physically attached to the host data processing apparatus 322 and may provide any combination of mechanical, electrical power, data, and device control functions to removable memory device 319, via interconnect 323 and host interconnect 324. Removable memory device 319 is removably coupled to host data processing apparatus 322 via interface 321.

Removable memory device 319 comprises memory device 320, wherein user data is stored, and host interconnect 324 which conveys any combination of device control, electrical power, data, or mechanical coupling to the interface 321. Mechanical constraining device 326 is controlled by access controller 327 and has an interference coupling with removable memory device 319, selectively preventing removal of removable memory device 319 in the direction denoted by arrow 325.

Biometric key interface 331 is activated with biometric information corresponding to a user from a user for use by security processor 329. Biometric key interface 331 is electrically coupled to and communicates with security processor 329 by interconnect bus 330. Security processor 329 obtains biometric key from biometric key interface 331 via interconnect bus 330 and controls electronic access controller 327 via interconnect bus 328. Security processor 329 performs a suitable algorithm, e.g. System 4 described in FIG. 4 and Method 500 in FIG. 5, to control access controller 327. Access controller 327 is controlled by security processor 329 to either permit or deny access to removable memory device 319. When instructed to permit, access controller 327 positions mechanical constraining device 326 to permit removal of removable memory device 319 in the direction indicated by arrow 325. When instructed to deny, access controller 327 positions mechanical constraining device 326 to constrain removal of removable memory device 319 in the direction indicated by arrow 325.

It is appreciated that as long as mechanical controller 327 remains in the “prohibit” function state, as instructed by security processor 329, mechanical constraining device 326 functions to effectively constrain removable memory device 319 and not allow removable memory device 319 to be removed from host data processing apparatus 322 without permanent, irreparable damage to removable memory device 319 with the ultimate effect of rendering removable memory device 319 unusable and inert. Hence, removable memory device 319 is secured. It is also appreciated that the memory device exemplified herein with reference to memory device 320 can have any shape, size, configuration, orientation, etc., and can house any kind of memory device, disk drive, circuitry, electronic apparatus, etc.

It is also appreciated that embodiments of the present invention may be practiced with functionality, exemplified herein with reference to mechanical restraining device 326, access controller 327, security processor 329, security status indicator 335, and biometric key interface 331, wherein the listed components are positioned, configured, oriented, etc. in such a way that the location of any or all of mechanical restraining device 326, access controller 327, security processor 329, security status indicator 335, or biometric key interface 331 is not limited to attachment to the host data processing apparatus 322, nor the removable memory device 319. In fact, any or all of mechanical restraining device 326, access controller 327, security processor 329, security status indicator 335, or biometric key interface 331 may be positioned, configured, oriented, etc in a variety of ingenious positions, configurations, orientations, etc, according to an embodiment of the present invention.

Security status indicator 335 is controlled by security processor 329 via control bus 336. Security status indicator 335 provides a visual indication of memory device 319's access permission. In this example, security status indicator 335 consists of a light emitting diode that produces a red indication to indicate removal is denied for memory device 319. Security status indicator 335 also produces a green indication to inform a user that removal of memory device 319 is permitted.

It is appreciated that the embodiments of the present invention may be practiced with functionality, exemplified herein with reference to security status indicator 335, in such a way that the nature of security status indicator 335 is not limited to a light emitting diode. In fact, security status indicator 335 may consist of one or more of a variety of indicators useful to the function of the removable memory device, including any or all of visual indicators, audible indicators, tactile indicators, electronic signals, etc.

Exemplary Removable Memory Securing System

FIG. 4 depicts an exemplary removable memory securing system according to the present invention. Access request message 431 notifies security coordination module 426 of a pending access request, initiating a user authentication and verification method, e.g. Method 500 as described in FIG. 5. Security coordination module 426, coordinating the steps of the security verification method, dispatches identity request message 425 to identity verification module 412. Identity verification module 412 activates biometric key interface 410 via link 411. Biometric key interface device 410 dispatches key value message 434 to identity verification module 412. Data conveyed by key value message 434 contain some state of biometric key interface that is correlated with some biometric aspect of a user interfacing with biometric key interface device 410. In one embodiment biometric key interface device 410 dispatches key value message 434 conveying a description of a user's fingerprint. In another embodiment, biometric key interface device 410 dispatches key value message 434 conveying a description of a user's retinal pattern. It is appreciated that the present invention may be practiced, with respect to biometric key interface device 410, with a variety of biometric devices, e.g. fingerprint, retinal scan, voice identifier, blood type, etc, as is appropriate for the type of access control that is desired.

Identity verification module 412 processes the data conveyed via key value message 434 and dispatches a user identity message 425 to security coordination module 426. Data conveyed by user identity message 425 contains some aspect of the user's identity. Security coordination module 426 dispatches permission request message 428 to permission verification module 421. Data conveyed by permission request message 428 contains some aspect of some combination of any or all of an aspect of the access request, an aspect of the user's identity, an aspect of memory device 435's state, or any other condition, state, status, input, etc. Permission verification module 421 processes data conveyed by permission request message 428 and dispatches a permission status message 422 to security coordination module 426. Data conveyed by permission status message 422 contains some aspect of the permissions attributable to said user interfacing with biometric key interface device 410.

Security coordination module 426 processes any or all of data conveyed by permission status message 422, user identity message 425, access request message 431, access request message 427, or any other condition, state, status, input, data, etc then dispatches access control message 423 to access control device 424. Data conveyed by access control message 423 contains some aspect of permitting or prohibiting access to memory device 435.

Access control device 424 either permits or prohibits access to removable memory device 435 based on some aspect of the data conveyed by access control message 431. Access control device 424 can consist of an electronic data switch, electromechanical latch, electro hydraulic securing mechanism, or any other mechanism that will effectively permit or prohibit access to some aspect of memory device 435. Data conveyed by access control message 423 instruct access control module 424 to set itself in the “permit” or “prohibit” state, thereby selectively securing access control to removable memory device 435.

It is appreciated that the present invention may be practiced with a variety of mechanisms, components, systems, or devices that will effectively permit or deny access to some aspect of memory device 435.

Access control device 424 receives access control message 423 from security coordination module 426. In one embodiment, access control device 424 may dispatch access request message 427, e.g. upon an attempt to physically remove the protected removable memory device 435. Access request message 427 notifies security coordination module 426 of a pending access request, initiating a user authentication and verification method, e.g. Method 500 as described in FIG. 5.

Exemplary Removable Memory Securing Method

FIG. 5 is a flowchart of an exemplary method 500 for securing access to a removable memory device using an embodiment of the present invention.

In Step 502, a request is made to access a removable memory device. The request can include any or all of: reading data, writing data, modifying data, deleting data, accessing device control functions, removal of the memory device, or any other action.

In Step 503, a biometric key is obtained from a biometric key interface activated with biometric information from a user.

In Step 504 the security system correlates the biometric key with a unique individual.

In Step 505, the access permission module determines the access permission of the user identified in Step 504. If the identified user authorization for the requested access is determined to be “authorized” step 510 is executed. If the user is not in the “authorized” list, Step 511 is executed.

In Step 510, an authorized user is given access to the removable memory device.

In Step 511, a non-authorized user is not given access to the removable memory device

While flow chart 500 shows a specific sequence of steps characteristic of one embodiment, other embodiments of the present invention are well suited to function with more or fewer steps. Likewise, the sequences of steps in various such embodiments can vary from those exemplified with process 500, e.g., depending upon the application.

It is appreciated that “access”, as described in Method 500, steps 502, 511, and 512, may refer to electronic, mechanical, or any other operation that would modify or change the state of any aspect of the removable memory device.

Exemplary Removable Memory Securing Apparatus with Fingerprint Reader

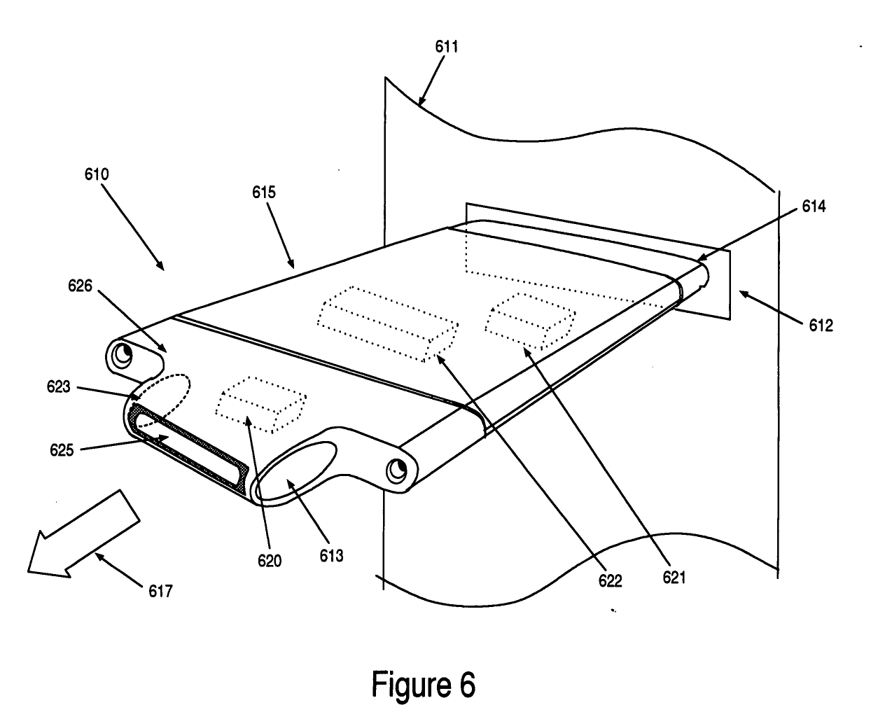

FIG. 6 depicts an exemplary removable storage device according to an embodiment of the present invention, in a view to demonstrate an exemplary configuration of certain components. In this example, removable memory device 610 contains a security processor 620, contained within housing 615, an electronic access controller 621, contained within housing 615, and biometric key interface devices 613 and 623, attached to housing form 626, which are activated with biometric information corresponding to a user. In this particular example, the biometric key interfaces devices 613 and 623 are situated on either side of housing form 626 in such a manner to permit the user to grasp housing form 626 with the thumb and forefinger, thereby engaging biometric key interface devices 613 and 623. In this example, the biometric key interface output and sate corresponds to fingerprint patterns.

Security status indicator 625 is a light emitting diode that provides visual feedback to a user, indicating some aspect of a status, said status representing some aspect of a removable memory device that might be valuable to a user. Host data processing apparatus 611 possess a removable memory interfaced connector 612, which conveys any combination of device control, electrical power, data, or mechanical coupling to removable memory device 610's host data processing apparatus interface 614. Removable memory device 610 is removably attachable to removable memory interfaced connector 612, and can be separated from removable memory interfaced connector 612 in the direction denoted by arrow 617. Biometric key interface device 613 provides means for a user to supply biometric information to security processor 620, which controls electronic access controller 621.

Security processor 620 controls electronic access controller 621 to allow or deny access to memory 622 in accordance with the System 4 described in FIG. 4 and Method 500 in FIG. 5. Security processor 620 also controls security status indicator 625, causing it to emit a red indicator when access is denied, a green indicator when access is allowed, and a yellow indicator while the system is processing data. It is appreciated that as long as electronic access controller 621 remains in the “prohibit” function, as instructed by security processor 620, no access to memory device 622 is possible. It is further appreciated that the memory device exemplified herein with reference to memory device 622 can have any shape, size, configuration, orientation, etc., and can house any kind of memory device, circuitry, electronic apparatus, etc.

It is also appreciated that embodiments of the present invention may be practiced with functionality, exemplified herein with reference to biometric key interfaces 613 and 623, wherein the biometric key interfaces 613 and 623 are positioned, configured, oriented, etc. in such a way that the location of biometric key interfaces 613 and 623 are not limited to a particular attachment to housing form 626. In fact, biometric key interfaces 613 and 623 may be positioned, configured, oriented, etc in a variety of ingenious positions, configurations, orientations, etc, according to an embodiment of the present invention.

It is further appreciated that embodiments of the present invention may be practiced with functionality, exemplified herein with reference to biometric key interfaces 613 and 623, in such a way that the nature of biometric key interfaces 613 and 623 are not limited to a fingerprint-sensing device. In fact, biometric key interfaces 613 and 623 may respond and operate with one or more of a variety of biometric key signals, including but not limited to retinal scan, fingerprint, DNA, voice patterns, body mass, etc.

It is further appreciated that the embodiments of the present invention may be practiced with functionality, exemplified herein with reference to security status indicator 625, in such a way that the nature of security status indicator 625 is not limited to a light emitting diode. In fact, security status indicator 625 may consist of one or more of a variety of indicators useful to the function of the removable memory device, including any or all of visual indicators, audible indicators, electronic signals, etc.

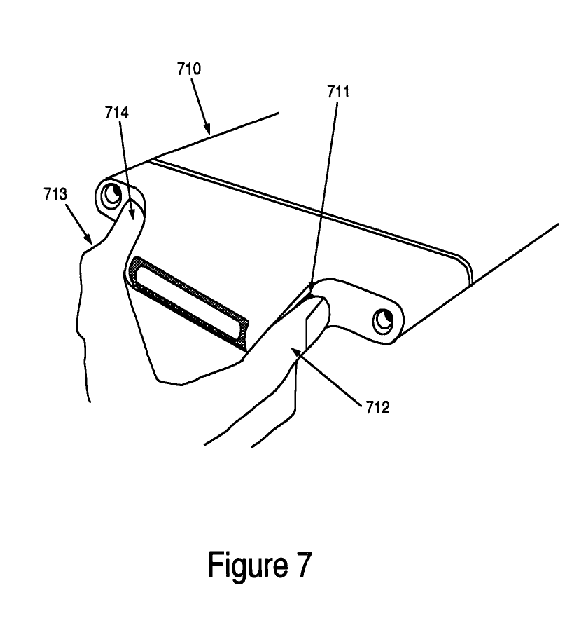

FIG. 7 depicts an exemplary removable storage device illustrating some details of the interaction between the user and the removable memory device according to an embodiment of the present invention. In this example, removable memory device 710 is identical to removable memory device 610, including biometric key interfaces 711 and 714. Biometric key interface 714 is occluded by thumb 713 thus not visible in this exemplary diagram. When a user is required to provide a biometric key, said user's finger 712 and thumb 713 interact with biometric key interfaces 711 and 714 to provide the biometric key data.

It is appreciated that embodiments of the present invention may be practiced with functionality, exemplified herein with reference to biometric key interfaces 711 and 714, wherein the biometric key interfaces 711 and 714 are positioned, configured, oriented, etc. in such a way that the location of biometric key interfaces 711 and 714 are not limited to a particular attachment to housing 710. In fact, biometric key interfaces 711 and 714 may be positioned, configured, oriented, etc in a variety of ingenious positions, configurations, orientations, etc, according to an embodiment of the present invention.

It is also appreciated that embodiments of the present invention may be practiced with functionality, exemplified herein with reference to biometric key interfaces 711 and 714, in such a way that the number of biometric key interfaces corresponding to or attached to housing 710 is not limited to two. In fact, any number of identical or different biometric key interfaces may be positioned, configured, oriented, etc in a variety of ingenious positions, configurations, orientations, etc, according to an embodiment of the present invention.

It is further appreciated that embodiments of the present invention may be practiced with functionality, exemplified herein with reference to biometric key interfaces 711 and 714, in such a way that the nature of biometric key interfaces 711 and 714 are not limited to fingerprint-sensing devices. In fact, biometric key interfaces 711 and 714 may respond and operate with one or more of identical or differing varieties of biometric key signals, including but not limited to retinal scan, fingerprint, DNA, voice patterns, body mass, salinity, etc.

Exemplary Removable Memory Securing Apparatus with Retinal Scanner

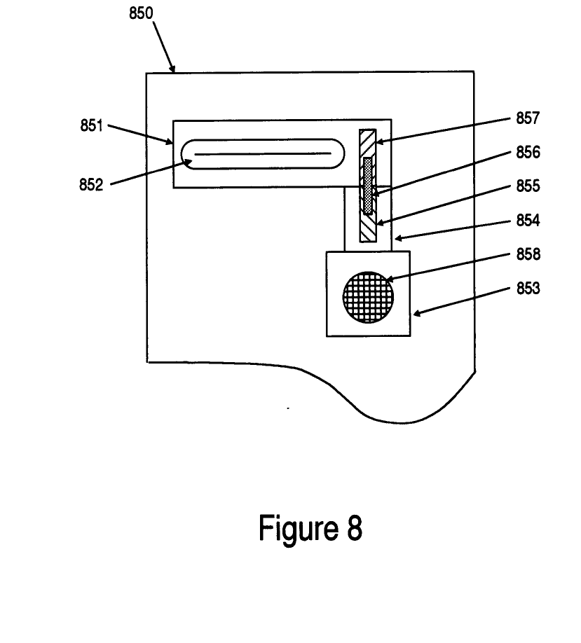

FIG. 8 depicts an exemplary data processing apparatus according to an embodiment of the present invention. Removable memory device 851 with handle 852 is installed into host data processing apparatus 850. Biometric key interface 858 is connected to security processor 853, which controls mechanical access controller 854 to allow or deny access to memory 851 in accordance with a suitable algorithm, e.g. the System 4 described in FIG. 4 and Method 500 in FIG. 5. Access controller 854 positions mechanical restraining device 856 to selectively permit or prohibit withdrawing of removable device 851 from host data processing apparatus 850.

It is appreciated that as long as mechanical controller 854 remains in the “prohibit” function state, as instructed by security processor 853, mechanical constraining device 856 functions to effectively constrain removable memory device 851 and not allow removable memory device 851 to be removed from host data processing apparatus 850 without permanent, irreparable damage to removable memory device 851 with the ultimate effect of rendering removable memory device 851 unusable and inert. Hence, removable memory device 851 is secured.

It is further appreciated that embodiments of the present invention may be practiced with functionality, exemplified herein with reference to mechanical restraining device 856, access controller 854, security processor 853, and biometric key interface 858, wherein the listed components are positioned, configured, oriented, etc. in such a way that the location of any or all of mechanical restraining device 856, access controller 854, security processor 854, or biometric key interface 858 is not limited to attachment to the host data processing apparatus 850, nor the removable memory device 851. In fact, any or all of mechanical restraining device 856, access controller 854, security processor 853, or biometric key interface 858 may be positioned, configured, oriented, etc in a variety of ingenious positions, configurations, orientations, etc, according to an embodiment of the present invention.

It is further appreciated that embodiments of the present invention may be practiced with functionality, exemplified herein with reference to biometric key interface 858, in such a way that the nature of biometric key interface 858 is not limited to a retina-sensing device. In fact, biometric key interface 858 may respond and operate with one or more of a variety of biometric key signals, including but not limited to fingerprint, DNA, voice patterns, body mass, etc.

Exemplary Removable USB Memory Device Securing Apparatus

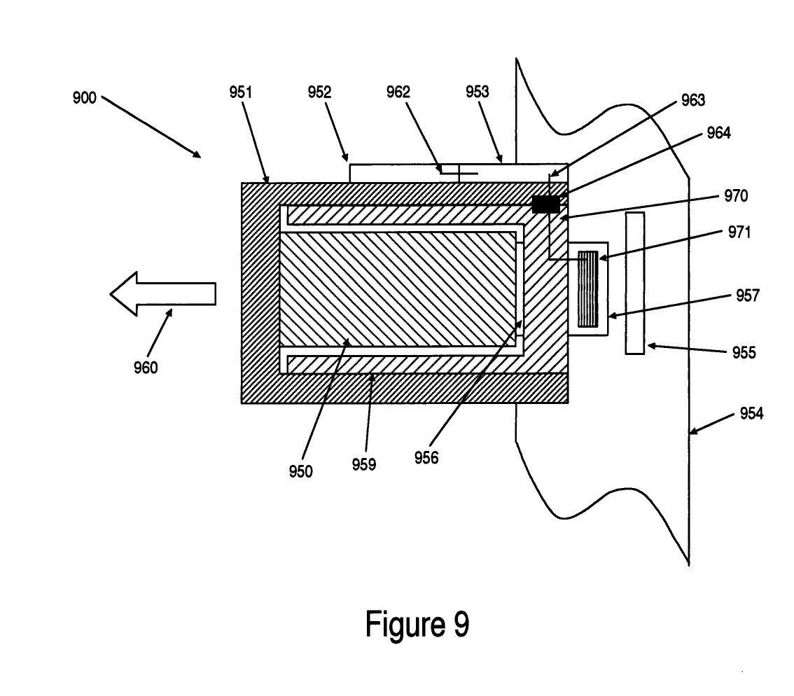

FIG. 9 depicts an exemplary removable memory device security adapter apparatus according to an embodiment of the present invention. Removable memory device adapter apparatus 900 is illustrated in the “closed” or “secured” condition. Host data processing apparatus interface connector 955 is part of the host data processing apparatus 954, and serves as the host data processing apparatus 954's' access to the removable memory device.

The removable memory device adapter apparatus 900 comprises a standard removable memory device 950, e.g. USB Thumb Drive, effectively contained and constrained by outer housing 951 and inner housing 959. The standard removable memory device interface connector 956 engages interface connector 957. Interface connector 957 communicates the bi-directional power, control, and data signals between the removable memory device 950 and the host data processing apparatus interface connector 955, subject to the state of electronic access controller 971. Electronic access controller 971 performs a switch function selectively permitting or prohibiting data transfer between the host data processing apparatus interface and the standard removable memory device 950, subject to control signals from security processor 953 via control bus 970.

Latch 964 performs a latching function, mechanically securing outer housing 951 to inner housing 959 in the closed position, subject to control signals from security processor 953 via control bus 963. When instructed by security processor 953, latch 964 permits outer housing 951 to be extended away from inner housing 959 in the direction indicated by arrow 960.

Biometric key interface 952 recovers biometric identity data provided by a user corresponding to said user for use by security processor 953. Biometric key interface 952 is electrically coupled to and communicates with security processor 953 by a power and data bus 962. Security processor 953, controls latch 964 via control bus 963 and electronic access controller 971 via control bus 970 to allow or deny access to standard removable memory device 950 in accordance with a suitable algorithm, e.g. System 4 described in FIG. 4 and Method 500 in FIG. 5.

It is appreciated that as long as outer housing 951 remains effectively latched with respect to inner housing 959 standard memory device 950 cannot be removed from removable memory device security adapter apparatus 900 without permanent, irreparable damage to standard removable memory device 950 with the ultimate effect of rendering standard removable memory device 950 unusable and inert. It is also appreciated that as long as electronic access controller 971 remains in the “prohibit” function, as instructed by security processor 953, no access to standard removable memory device 950 is possible. It is further appreciated that the standard removable memory device exemplified herein with reference to standard removable memory device 950 can have any shape, size, configuration, orientation, etc., and can house any kind of memory device, circuitry, electronic apparatus, etc.

Exemplary Removable USB Memory Device Securing Apparatus

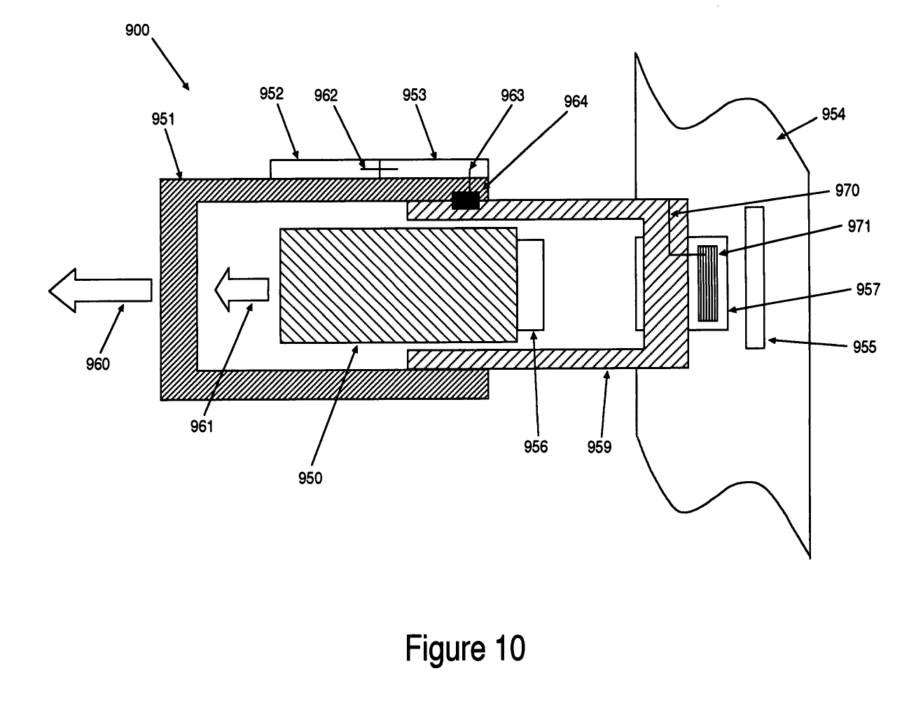

FIG. 10 depicts a view exemplary removable memory device security adapter apparatus 900 according to an embodiment of the present invention. The depicted device is identical in construction to removable memory device security adapter apparatus 900 depicted in FIG. 9. In this depiction, security processor 953 has positioned latch 964 such that outer housing 951 is no longer constrained with respect to inner housing 959. Therefore outer housing 951 can be moved in the direction indicated by arrow 960. Since outer housing 951 can be extended away from inner housing 959, it no longer constrains or restrains standard removable memory device 950. Standard removable device 950 may now be removed from the removable memory device security adapter apparatus 900 and accessed using normal, non-secure methods.

What is claimed is:

1. A method for securing data on a removable memory device, comprising:
detecting an attempt by a user to access said removable memory device wherein said removable memory device is removably coupled to a computing apparatus and accessible therewith;
upon said attempt to access said data, authenticating an identity of said user, wherein said authenticating comprises approving a biometric parameter associated with said user applied to a biometric key interface device;
upon said authenticating, wherein if said user identity corresponds to authorized access to said data, access is enabled; and
upon said authenticating, wherein if said user identity does not corresponds to authorized access to said data, access to secure said data is inhibited.

2. The method as cited in claim 1 further comprising: controlling a physical removal of said removable storage device from said computing apparatus.

3. The method as cited in claim 2 wherein said controlling is accomplished through a latch apparatus that selectively prevents removal of said removable memory device from said computing apparatus.

4. The method as cited in claim 1 wherein said access to said data is accomplished through a switch apparatus that selectively controls electronic data access of said removable memory device from said computing apparatus.

5. The method as cited in claim 4 wherein said controlling comprises controlling an electronic access to said data, and said electronic access comprises any combination of one or more of reading, writing, deleting, or modifying said data.

6. The method as cited in claim 1 wherein said inhibiting said access to said data comprises permanently erasing and deleting said data if said access is attempted by said user when said user is not authorized.

7. The method as cited in claim 1 wherein said authentication of said user's authorization comprises:
applying a biometric authorization code corresponding to said user to said biometric key interface device;
verifying a user's authorization based on said biometric authorization code; and
controlling access to said removable memory device based on said user's authorization.

8. An apparatus for securing data on a removable memory device comprising:
a data processing apparatus;
a removable memory device removably coupled to said data processing apparatus;
a housing wherein the housing contains said removable memory device;
an access controller, coupled to said data processing apparatus and said removable memory device, wherein said access controller secures access to said removable memory device;
a biometric key interface wherein the biometric key interface state is dependent on a biometric mechanism provided by a user wherein the biometric mechanism establishes an identity of said user; and
an indicator wherein the appearance of said indicator indicates a status of the access permissions of said removable memory device.

9. The apparatus of claim 8 further comprising: a security processor coupled to said access controller and said biometric key interface, wherein said security processor controls said functions of said access controller and said security processor, via said biometric key interface, determines a state of said biometric key interface.

10. The apparatus of claim 9, wherein said security processor, via a identity authorization system module, compares said state of said biometric key interface to a criteria to establish identity of said user.

11. The apparatus of claim 10, wherein said security processor, via a access control module, controls said functions of said access controller, based on said authentication function by said security processor, and said access controller controls access to said removable memory device.

12. The apparatus as cited in claim 11 wherein said controlling of access to said removable memory device comprises controlling a physical removal of said removable storage device from said housing.

13. The apparatus as cited in claim 12 wherein said controlling of a physical removal of said removable memory device is accomplished through a latch apparatus that selectively prevents removal of said removable memory device from said computing apparatus.

14. The apparatus as cited in claim 11 wherein said controlling of access to said removable memory device comprises controlling an electronic access to said data; wherein said electronic access comprises any combination of one or more of reading, writing, deleting, or modifying said data.

15. The apparatus as cited in claim 14 wherein said controlling of an electronic access to said data is accomplished through a switch apparatus that selectively prevents electronic data access of said removable memory device from said computing apparatus.

16. The apparatus as cited in claim 11 wherein said controlling of access to said removable memory device comprises permanently erasing or deleting said data if said access is attempted by said user when said user is not authorized.

17. The apparatus as cited in claim 8 wherein said biometric key interface is coupled to said removable memory device.

18. The apparatus as cited in claim 8 wherein said biometric key interface is coupled to said data processing apparatus housing.

19. The apparatus as cited in claim 8 wherein said biometric key interface is arranged to engage the user's finger.

20. The apparatus as cited in claim 8 wherein said biometric key interface comprises a plurality of biometric key interfaces, arranged to engage one or more of the user's thumbs and fingers.
